(19) United States
(12) Patent Application Publication
(10) Pub. No.: US 2026/0121253 A1
(43) Pub. Date: Apr. 30, 2026

(54) SECONDARY BATTERY

(71) Applicant: Samsung SDI Co., Ltd., Yongin-si (KR)

(72) Inventors: Dong Hyuk KO, Yongin-si (KR); Jeong Yeon LEE, Yongin-si (KR)

(21) Appl. No.: 19/008,387

(22) Filed: Jan. 2, 2025

(30) Foreign Application Priority Data
Jul. 8, 2024 (KR) 10-2024-0089407

(51) Int. Cl. H01M 50/538; H01M 50/474; H01M 50/533; H01M 50/586

(52) U.S. Cl. CPC H01M 50/538; H01M 50/474; H01M 50/533; H01M 50/586

(57) ABSTRACT

A secondary battery includes a case; and an electrode assembly and a conductive plate accommodated in the case, the electrode assembly includes a first electrode assembly part and a second electrode assembly part, a partition wall is between the first electrode assembly part and the second electrode assembly part, the conductive plate includes a first conductive plate on the electrode assembly and a second conductive plate under the electrode assembly, the first conductive plate includes a first conductive part and a second conductive part that are insulated by an insulating member, the first conductive part is electrically connected to the first electrode assembly part, the second conductive part is electrically connected to the second electrode assembly part, and the second conductive plate is electrically connected to the first electrode assembly part and the second electrode assembly part.

### CROSS-REFERENCE TO THE RELATED APPLICATION

The present application claims priority to and the benefit of Korean Patent Application No. 10-2024-0089407, filed on Jul. 8, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, whereas large-capacity secondary batteries are widely used as power sources for driving motors in hybrid vehicles and electric vehicles and for storing power (e.g., home and/or utility scale power storage). A secondary battery generally includes an electrode assembly including a positive electrode and a negative electrode, a case accommodating the positive and negative electrodes, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery capable of achieving a high voltage.

A secondary battery according to the embodiment comprises a case; and an electrode assembly, a partition wall, and a conductive plate accommodated in the case, the electrode assembly includes a first electrode assembly part and a second electrode assembly part, a partition wall is between the first electrode assembly part and the second electrode assembly part, the conductive plate includes a first conductive plate on the electrode assembly and a second conductive plate under the electrode assembly, the first conductive plate comprises a first conductive part and a second conductive part that are insulated by an insulating member, the first conductive part is electrically connected to the first electrode assembly part, the second conductive part is electrically connected to the second electrode assembly part, and the second conductive plate is electrically connected to the first electrode assembly part and the second electrode assembly part.

The first electrode assembly part comprises a 1-1 electrode, a 2-1 electrode, and a first separator, the second electrode assembly part comprises a 1-2 electrode, a 2-2 electrode, and a second separator, the 1-1 electrode comprises a 1-1 uncoated portion where an active material layer is not provided, the 2-1 electrode comprises a 2-1 uncoated portion where an active material layer is not provided, the 1-2 electrode includes a 1-2 uncoated portion where an active material layer is not provided, the 2-2 electrode includes a 2-2 uncoated portion where an active material layer is not provided, the 1-1 electrode and the 1-2 electrode are positive electrodes, and the 2-1 electrode and the 2-2 electrode are negative electrodes.

The 1-1 uncoated portion may be at an upper end of the first electrode assembly part, the 2-1 uncoated portion may be at a lower end of the first electrode assembly part, the 1-2 uncoated portion may be a lower end of the second electrode assembly part, and the 2-2 uncoated portion may be at an upper end of the second electrode assembly part.

The 1-1 uncoated portion and the 2-2 uncoated portion may be electrically connected to the first conductive plate, and the 2-1 uncoated portion and the 1-2 uncoated portion may be electrically connected to the second conductive plate.

The partition wall may comprise a different material from the first separator and the second separator.

A thickness of the partition wall may be in a range from approximately 20 μm to approximately 100 μm.

The first electrode assembly part and the second electrode assembly part may be connected in series.

The first electrode assembly part may have a first voltage, the second electrode assembly part may have a second voltage, and the first voltage and the second voltage may be the same or different.

A voltage of the electrode assembly may be a sum of the first voltage and the second voltage.

The partition wall may comprise a resin, and the movement of lithium ions may be blocked by the partition wall.

The partition wall may comprise a first region and a second region, the first region may be between the first electrode assembly part and the second electrode assembly part, and the second region may be on a portion of at least one of the 1-1 uncoated portion and the 2-1 uncoated portion.

The secondary battery may further comprise a first blocking member disposed between the partition wall and the insulating member; and a second blocking member between the partition wall and the second conductive plate.

The secondary battery may further comprise a blocking member between the partition wall and the second conductive plate, the insulating member may comprise a first region and a second region, the first region may be in a hole of the first conductive plate, and the second region may be between the first region and the partition wall.

The electrode assembly may further comprise a third electrode assembly part, the second electrode assembly part may be between the first electrode assembly part and the third electrode assembly part, the third electrode assembly part may comprise a 1-3 electrode, a 2-3 electrode, and a third separator, the 1-3 electrode may comprise a 1-3 uncoated portion where an active material layer is not provided, the 2-3 electrode comprises a 2-3 uncoated portion where an active material layer is not provided, the 1-3 electrode may be a positive electrode, the 2-3 electrode may be a negative electrode, the 1-3 uncoated portion may be on the first electrode assembly part, the 2-3 uncoated portion may be under the first electrode assembly part, the 1-3 uncoated portion may be electrically connected to the first conductive plate, and the 2-3 uncoated portion may be electrically connected to the second conductive plate.

The partition wall may comprise a first partition wall between the first electrode assembly part and the second electrode assembly part, and a second partition wall between the second electrode assembly part and the third electrode assembly part.

The widths of the first partition wall and the second partition wall may be different

The first electrode assembly part may have a first voltage, the second electrode assembly part may have a second voltage, and the third electrode assembly may have a first voltage. The first voltage, the second voltage, and the third voltage may be the same or different.

A voltage of the electrode assembly may be a sum of the first voltage, the second voltage, and the third voltage.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to a first embodiment.

FIG. 2 is a top view showing an electrode assembly according to the first embodiment.

FIG. 3 is a sectional view taken along the B-B′ section of FIG. 2.

FIGS. 4 to 7 are views showing the electrode assembly and a conductive plate coupled according to the first embodiment.

FIG. 8 is a sectional view taken along the A-A′ section of FIG. 1.

FIG. 9 is a top view showing an electrode assembly according to a second embodiment.

FIG. 10 is a sectional view taken along the C-C′ section of FIG. 9.

FIGS. 11 to 13 are views showing the electrode assembly and a conductive plate coupled according to the second embodiment

FIG. 14 is a perspective view showing a battery module including secondary batteries according to some embodiments.

FIGS. 15 and 16 are perspective views showing a battery pack including battery modules according to some embodiments.

FIGS. 17 and 18 are perspective views and a side view showing a vehicle including battery packs according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the following description, the width direction of a case is defined in the X axis direction, and the height direction of the case is defined in the Y axis direction.

Hereinafter, a secondary battery according to an embodiment will be described with reference to the drawings.

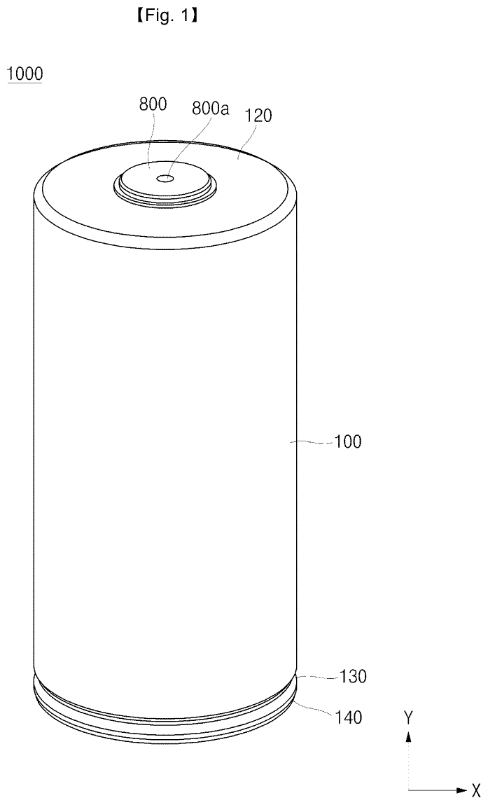

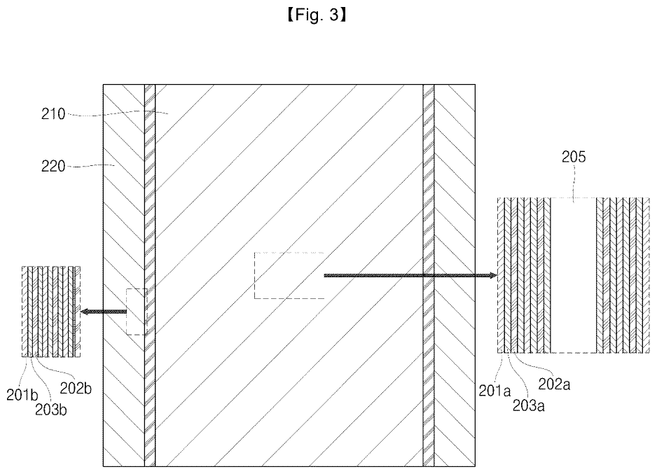

Referring to FIGS. 1 to 8, a secondary battery 1000 according to a first embodiment may include a case 100 and an electrode assembly 200.

The case 100 may form the overall appearance of the secondary battery 1000. The case 100 may include a conductive metal such as aluminum, an aluminum alloy, or nickel-plated steel. The case 100 may provide a space in which the electrode assembly 200 is accommodated. For example, the case 100 may include an accommodating portion, and the electrode assembly 200 may be accommodated inside the accommodating portion.

The case 100 may be formed in various shapes. For example, the case 100 may be formed in a circular, prismatic, or pouch shape. However, the embodiment is not limited thereto. Hereinafter, for convenience of explanation, the case 100 will be described as being formed in a circular shape.

The electrode assembly 200 may be accommodated inside the case 100.

The electrode assembly 200 may include a plurality of electrode assembly parts. For example, the electrode assembly 200 may include at least two or more electrode assembly portions. For example, the electrode assembly 200 may include a first electrode assembly part 210 and a second electrode assembly part 220. The first electrode assembly part 210 and the second electrode assembly part 220 may be concentric or substantially concentric.

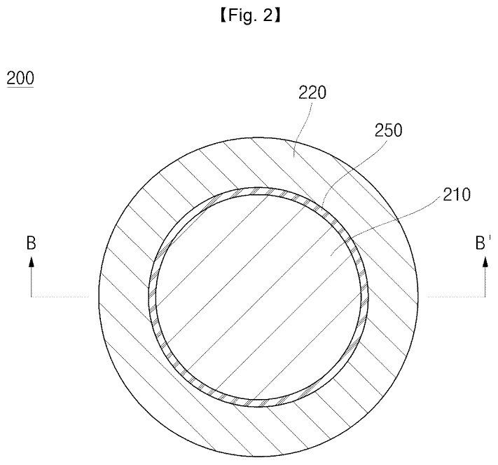

Referring to FIGS. 2 to 4, the first electrode assembly part 210 may include a 1-1 electrode 201a, a 2-1 electrode 202a, and a first separator 203a.

The first electrode assembly part 210 may be wound in a jelly-roll shape. The first electrode assembly part 210 may be wound in a state where the first separator 203a is between the 1-1 electrode 201a and the 2-1 electrode 202a.

In one or more embodiments, the first electrode assembly 210 may include a hollow portion 205. The hollow portion 205 may be formed at the center (or substantially the center) of the winding axis of the first electrode assembly part 210.

The second electrode assembly part 220 may include a 1-2 electrode 201b, a 2-2 electrode 202b, and a second separator 203b.

The second electrode assembly part 220 may be wound in a jelly-roll shape. The second electrode assembly part 220 may be wound in a state where the second separator 203b is between the 1-2 electrode 201b and the 2-2 electrode 202b. The second electrode assembly 220 may be wound around the first electrode assembly 210 and about an axis of the first electrode assembly 210. In one or more embodiments, the second electrode assembly 220 does not include a separate hollow portion.

The 1-1 electrode 201a may include a 1-1 base material and a 1-1 active material layer. The 1-1 active material layer may be on the 1-1 base material. For example, the 1-1 active material layer may be on one surface and the other surface (i.e., the opposite surface) of the 1-1 base material.

The 1-2 electrode 201b may include a 1-2 base material and a 1-2 active material layer. The 1-2 active material layer may be on the 1-2 base material. For example, the 1-2 active material layer may be on one surface and the other surface (i.e., the opposite surface) of the 1-2 base material.

The 1-1 base material may include the 1-1 uncoated portion 211a. The 1-1 active material layer is not on the 1-1 uncoated portion 211a. That is, the 1-1 uncoated portion 211a may be defined as an area where the 1-1 active material layer is not provided. The 1-1 uncoated portion 211a may be on the upper portion of the first electrode assembly part 210. In one or more embodiments, the 1-1 uncoated portion 211a may be on the lower portion of a first conductive plate 310.

The 1-2 base material may include the 1-2 uncoated portion 221a. The 1-2 active material layer is not provided on the 1-2 uncoated portion 221a. That is, the 1-2 uncoated portion 221a may be defined as an area where the 1-2 active material layer is not provided. The 1-2 uncoated portion 221a may be provided on the lower portion of the second electrode assembly part 220. In one or more embodiments, the 1-2 uncoated portion 221a may be on the upper portion of a second conductive plate 320.

The 1-1 electrode 201a and the 1-2 electrode 201b may be positive electrode. In one or more embodiments, the 1-1 electrode 201a may be the positive electrode of the first electrode assembly part 210, and the 1-2 electrode 201b may be the positive electrode of the second electrode assembly part 220.

The 1-1 electrode 201a and the 1-2 electrode 201b may include the same material. For example, the 1-1 base material and the 1-2 base material may include aluminum. In one or more embodiments, the 1-1 active material layer and the 1-2 active material layer may include a transition metal oxide.

The 2-1 electrode 202a may include the 2-1 base material and the 2-1 active material layer. The 2-1 active material layer may be on the 2-1 base material. For example, the 2-1 active material layer may be on one surface and the other surface (i.e., the opposite surface) of the 2-1 base material.

The 2-2 electrode 202b may include the 2-2 base material and the 2-2 active material layer. The 2-2 active material layer may be on the 2-2 base material. For example, the 2-2 active material layer may be on one surface and the other surface (i.e., the opposite surface) of the 2-2 base material.

The 2-1 base material may include a 2-1 uncoated portion 211b. The 2-1 active material layer is not provided on the 2-1 uncoated portion 211b. That is, the 2-1 uncoated portion 211b may be defined as an area where the 2-1 active material layer is not provided. The 2-1 uncoated portion 211b may be provided on the lower portion of the first electrode assembly part 210, and the 2-1 uncoated portion 211b may be provided on the upper portion of the second conductive plate 320.

The 2-2 base material may include a 2-2 uncoated portion 221b. The 2-2 active material layer is not provided on the 2-2 uncoated portion 221b. That is, the 2-2 uncoated portion 221b may be defined as an area where the 2-2 active material layer is not provided. The 2-2 uncoated portion 221b may be provided on the upper portion of the second electrode assembly part 220. In one or more embodiments, the 2-2 uncoated portion 221b may be provided on the lower portion of the first conductive plate 310.

The 2-1 electrode 202a and the 2-2 electrode 202b may be negative electrodes. In one or more embodiments, the 2-1 electrode 202a may be the negative electrode of the first electrode assembly part 210, and the 2-2 electrode 202b may be the negative electrode of the second electrode assembly 220.

The 2-1 electrode 202a and the 2-2 electrode 202b may include the same material. For example, the 2-1 base material and the 2-2 base material may include copper or nickel, and the 2-1 active material layer and the 2-2 active material layer may include graphite.

The first separator 203a may be between the 1-1 electrode 201a and the 2-1 electrode 202a. The second separator 203b may be between the 1-2 electrode 201b and the 2-2 electrode 202b.

The first separator 203a may be configured to prevent a short circuit between the 1-1 electrode 201a and the 2-1 electrode 202a while allowing the movement of lithium ions. The second separator 203b may be configured to prevent a short circuit between the 1-2 electrode 201b and the 2-2 electrode 202b while allowing the movement of lithium ions.

The first separator 203a and the second separator 203b may include the same material. For example, the first separator 203a and the second separator 203b may include a polyethylene film, a polypropylene film, or a polyethylene-polypropylene film.

The secondary battery may include a partition wall 250. The partition wall 250 may be between the first electrode assembly part 210 and the second electrode assembly part 220. The first electrode assembly part 210 and the second electrode assembly part 220 may be separated by the partition wall 250. In one or more embodiments, the first electrode assembly part 210 and the second electrode assembly part 220 do not contact each other due to the partition wall 250.

The partition wall 250 may be located (e.g., inserted into the case 100) after the first electrode assembly part 210 is formed. In one or more embodiments, the partition wall 250 may be located (e.g., inserted into the case 100) before the second electrode assembly part 220 is formed.

The 1-1 electrode 201a, the 1-2 electrode 201b, and the first separator 203a may be wound to form the first electrode assembly part 210. In one or more embodiments, the 1-1 electrode 201a, the 1-2 electrode 201b, and the first separator 203a are wound with the winding core as the axis. In this manner, the first electrode assembly part 210 with a hollow portion formed at the winding center may be formed.

Next, the partition wall 250 is provided on the outer surface of the first electrode assembly part 210. The partition wall 250 may cover the entire (or substantially the entire) or partial outer surface of the first electrode assembly part 210.

Next, the second electrode assembly part 220 is formed. For example, the 2-1 electrode 201b, the 2-2 electrode 202b, and the second separator 203b are wound to form the second electrode assembly part 220. In one or more embodiments, the 2-1 electrode 201b, the 2-2 electrode 202b, and the second separator 203b are wound with the winding core and the first electrode assembly part 210 as an axis. In this manner, the second electrode assembly part 220 in contact with the partition wall 250 may be formed.

The partition wall 250 is between the first electrode assembly part 210 and the second electrode assembly part 220. Therefore, ion exchange between the first electrode assembly part 210 and the second electrode assembly part 220 may be blocked by the partition wall 250. The shape of the secondary battery may be maintained by the partition wall 250. In one or more embodiments, the partition wall 250 may fix the shapes of the first electrode assembly part 210 and the second electrode assembly part 220. Accordingly, the secondary battery may be prevented or reduced (mitigated) from collapsing at the center of the assembly (e.g., at the winding axis).

In addition, the shape of the first electrode assembly part 210 may be maintained by the partition wall 250. In one or more embodiments, when the first electrode assembly part 210 swells due to overcharging, the deformation of the first electrode assembly part 210 may be prevented or reduced (mitigated) by the partition wall 250.

The partition wall 250 may include a different material from the first separator 203a and the second separator 203b. In one or more embodiments, the partition wall 250 may include a material that does not allow the movement of lithium ions. In one or more embodiments, the partition wall 250 may include a resin. In one or more embodiments, the partition wall 250 may include polyethylene terephthalate (PET), polyimide (PI), or PTFE (Polytetrafluoroethylene).

Therefore, the first electrode assembly part 210 and the second electrode assembly part 220 do not exchange ions due to the partition wall 250. Therefore, the first electrode assembly part 210 and the second electrode assembly part 220 may be electrically separated while each having an individual (separate) voltage.

The partition wall 250 may have a set thickness. For example, the thickness of the partition wall 250 may be greater than the thickness of the 1-1 base material, the 1-2 base material, the 2-1 base material, and the 2-2 base material. For example, the thickness of the partition wall 250 may be in a range from approximately 20 [symbol] to approximately 100 [symbol] , in a range from approximately 40 [symbol] to approximately 80 [symbol] , or in a range from approximately 50 [symbol] to approximately 70 [symbol] . The thickness of the partition wall 250 may vary depending on the material forming the partition wall 250. In one or more embodiments, the thickness of the partition wall 250 may vary depending on the number of turns of the partition wall 250.

If the thickness of the partition wall 250 is less than 20 [symbol] , the strength of the partition wall 250 may decrease. Therefore, the partition wall 250 may be damaged. Accordingly, ion exchange may occur between the first electrode assembly part 210 and the second electrode assembly part 220. If the thickness of the partition wall 250 exceeds 100 [symbol] , the size of the secondary battery may increase due to the partition wall 250, and the sizes of the first electrode assembly part 210 and the second electrode assembly part 220 may decrease due to the partition wall 250. Accordingly, the capacity of the secondary battery may decrease.

The first electrode assembly part 210 and the second electrode assembly part 220 may have set sizes. The sizes of the electrode assembly part 210 and 220 may be defined by the size of the base material of the electrode assembly parts. In one or more embodiments, the first electrode assembly part 210 may have a first size, and the second electrode assembly part 220 may have a second size. The first size may be the area of the electrode of the first electrode assembly part. The second size may be the area of the electrode of the second electrode assembly part.

The first size and the second size may be the same (or substantially the same), or the first size and the second size may be different. The first size and the second size may be formed in various sizes to achieve a desired voltage of the secondary battery.

The first electrode assembly part 210 and the second electrode assembly part 220 may have a set voltage. The first electrode assembly part 210 may have a first voltage and the second electrode assembly part 220 may have a second voltage. The first voltage and the second voltage may be the same (or substantially the same), or the first voltage and the second voltage may be different. The total voltage of the secondary battery may be determined by the first voltage and the second voltage. In one or more embodiments, the first electrode assembly part 210 and the second electrode assembly part 220 may be electrically connected. For example, the first electrode assembly part 210 and the second electrode assembly part 220 may be connected in series. Accordingly, the voltage of the secondary battery may be a third voltage which is a sum of the first voltage and the second voltage.

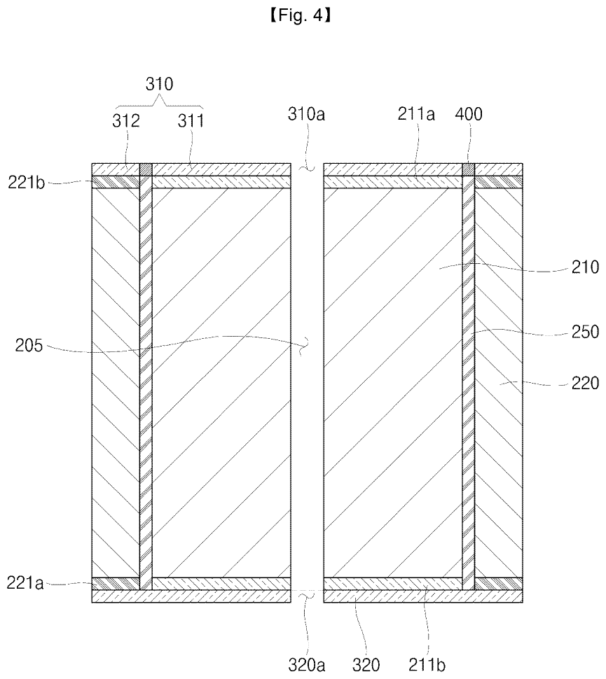

Referring to FIG. 4, the first conductive plate 310 and the second conductive plate 320 may be on the electrode assembly 200. In one or more embodiments, the first conductive plate 310 may be on the upper portion of the electrode assembly 200, and the second conductive plate 320 may be on the lower portion of the electrode assembly 200.

The first conductive plate 310 may be connected to the electrode assembly 200. In one or more embodiments, the first conductive plate 310 may be electrically connected to the first electrode assembly part 210 and the second electrode assembly part 220.

The first conductive plate 310 may include a metal. For example, the first conductive plate 310 may include aluminum (Al).

The first conductive plate 310 may include an insulating member 400. In one or more embodiments, the first conductive plate 310 may include a hole. The hole may be formed in a closed loop (annular) shape. The insulating member 400 may be inserted into the hole. Accordingly, the first conductive plate 310 may include a first conductive part 311 and a second conductive part 312 separated by the insulating member 400. The first conductive part 311 and the second conductive part 312 may be separated from each other by the insulating member 400. The first conductive part 311 and the second conductive part 312 may be insulated by the insulating member 400.

The first conductive part 311 may be connected to the first electrode assembly part 210. In one or more embodiments, the first conductive part 311 may be electrically connected to the 1-1 base material. In one or more embodiments, the first conductive part 311 may be electrically connected to the 1-1 uncoated portion 211a. In one or more embodiments, the first conductive part 311 and the 1-1 uncoated portion 211a may be coupled by welding. Therefore, the first conductive part 311 may be electrically connected to the positive electrode of the first electrode assembly part 210.

The second conductive part 312 may be connected to the second electrode assembly part 220. In one or more embodiments, the second conductive part 312 may be electrically connected to the 2-2 base material. In one or more embodiments, the second conductive part 312 may be electrically connected to the 2-2 uncoated portion 221b. In one or more embodiments, the second conductive part 312 and the 2-2 uncoated portion 221b may be coupled by welding. Accordingly, the second conductive part 312 may be electrically connected to the negative electrode of the second electrode assembly part 220.

The first conductive plate 310 may be connected to a terminal and the case 100. That is, the first conductive plate 310 may be a current collecting plate. The connection of the first conductive plate 310 and other members will be described in detail below.

The first conductive plate 310 may include at least one hole. For example, the first conductive plate 310 may include a first hole 310a. The first hole 310a may overlap the hollow portion 205 in the Y axis direction. Gas may be generated due to overcharging or malfunction of the electrode assembly. The gas may be discharged to the outside through the hollow portion 205 and the first hole 310a.

The second conductive plate 320 may be connected to the electrode assembly 200. In one or more embodiments, the second conductive plate 320 may be electrically connected to the first electrode assembly part 210 and the second electrode assembly part 220.

The second conductive plate 320 may include a metal. For example, the second conductive plate 310 may include aluminum (Al).

The second conductive plate 320 may include at least one hole. For example, the second conductive plate 320 may include a second hole 320a. The second hole 320a may overlap the hollow portion 205 and the first hole 310a in the Y axis direction. Gas may be generated due to overcharging or malfunction of the electrode assembly. The gas may be discharged to the outside through the hollow portion 205, the first hole 310a, and the second hole 320a.

The second conductive plate 320 may be connected to the first electrode assembly part 210. In one or more embodiments, the second conductive plate 320 may be electrically connected to the 2-1 base material. In one or more embodiments, the second conductive plate 320 may be electrically connected to the 2-1 uncoated portion 211b. For example, the second conductive plate 320 and the 2-1 uncoated portion 211b may be coupled by welding. Accordingly, the second conductive plate 320 may be electrically connected to the negative electrode of the second electrode assembly part 220.

The second conductive plate 320 may be connected to the second electrode assembly part 220. In one or more embodiments, the second conductive plate 320 may be electrically connected to the 1-2 base material. In one or more embodiments, the second conductive plate 320 may be electrically connected to the 1-2 uncoated portion 221a. For example, the second conductive plate 320 and the 1-2 uncoated portion 221a may be coupled by welding. Accordingly, the second conductive plate 320 may be electrically connected to the positive electrode of the second electrode assembly part 220.

The 2-1 uncoated portion 211b and the 1-2 uncoated portion 221a may be connected by the second conductive plate 320. In one or more embodiments, the 2-1 uncoated portion 211b and the 1-2 uncoated portion 221a may be connected in series by the second conductive plate 320.

Accordingly, the electrode assembly 200 may have a third voltage. In addition, the positive electrode of the electrode assembly 200 may be the first electrode assembly part 210, and the negative electrode of the electrode assembly 200 may be the second electrode assembly part 220.

The secondary battery according to the first embodiment includes the electrode assembly. The electrode assembly includes the first electrode assembly part and the second electrode assembly part. The electrode assembly also includes the partition wall. The partition wall is between the first electrode assembly part and the second electrode assembly part.

The first electrode assembly 210 part allows lithium ions to move between the positive and negative electrodes, and the second electrode assembly 220 part allows lithium ions to move between the positive and negative electrodes. However, lithium ions do not move between the first electrode assembly part 210 and the second electrode assembly part 220 due to the partition wall 250. Accordingly, the electrode assembly includes a plurality of electrode assembly parts having individual voltages. In one or more embodiments, the electrode assembly includes the first electrode assembly part 210 having a first voltage and the second electrode assembly part 220 having a second voltage.

The first electrode assembly part 210 and the second electrode assembly part 220 are electrically connected. In one or more embodiments, the first electrode assembly part 210 and the second electrode assembly part 220 are connected in series. Therefore, the electrode assembly has a third voltage which is a sum of the first voltage and the second voltage.

Therefore, the voltage of the secondary battery according to the first embodiment may increase. Therefore, when using the same power, the current of the secondary battery may be reduced. Accordingly, the power loss of the secondary battery according to the first embodiment is reduced. That is, the power loss is proportional to the current of the secondary battery. Since the current of the secondary battery is reduced, the power loss of the secondary battery is also reduced.

Since the current of the secondary battery is reduced, the internal heat generation of the secondary battery is reduced. Accordingly, the internal temperature of the secondary battery may be prevented (or at least mitigated) from increasing. Accordingly, the performance and safety of the secondary battery may be improved.

The secondary battery according to the first embodiment may achieve a high voltage with one secondary battery. Conventionally, in order to realize a high voltage, a plurality of secondary batteries are connected in series. However, the secondary battery according to the first embodiment achieves a high voltage with one secondary battery. Therefore, the size of the battery module or battery pack may be reduced.

The secondary battery according to the first embodiment may be utilized easily. Conventionally, when using stored energy, the current applied from the secondary battery was converted using a transformer. However, since the secondary battery according to the first embodiment may design the voltage according to the device used, a separate transformer is not required.

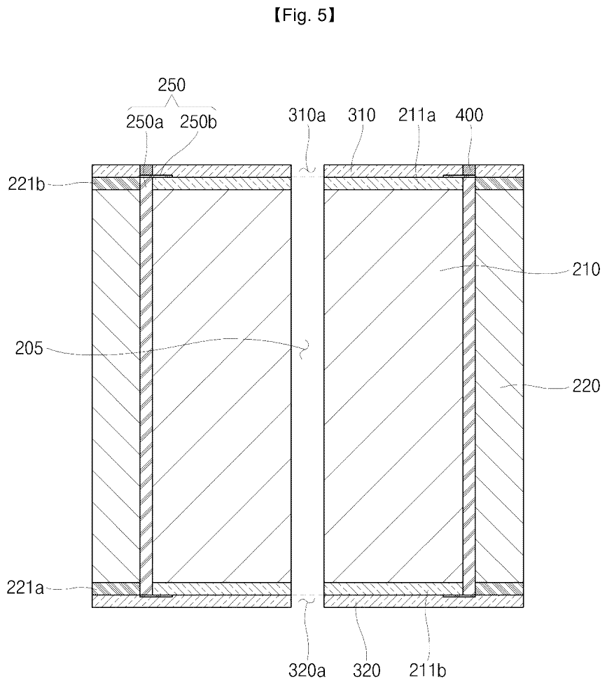

Referring to FIGS. 5 to 7, the electrode assembly of the secondary battery according to the first embodiment may be formed in various shapes.

Referring to FIG. 5, the partition wall 250 may be on at least one of the upper and lower surfaces of the first electrode assembly part 210.

The partition wall 250 may include a first region 250a and a second region 250b. The first region 250a may be between the first electrode assembly part 210 and the second electrode assembly part 220. The second region 250b may be bent at an upper and/or a lower end of the first region 250a. In one or more embodiments, the second region 250b may be bent at at least one end of the first region 250a.

The second region 250b may be on the 1-1 uncoated portion 211a. The second region 250b may be on a portion of the 1-1 uncoated portion 211a. For example, the second region 250b may be on an area of approximately 5% or less, approximately 3% or less, or approximately 1% or less of the 1-1 uncoated portion 211a.

In one or more embodiments, the second region 250b may be on the 2-1 uncoated portion 211b. The second region 250b may be on a portion of the 2-1 uncoated portion 211b. For example, the second region 250b may be disposed on an area of approximately 5% or less, approximately 3% or less, or approximately 1% or less of the 2-1 uncoated portion 211b.

In one or more embodiments, the second region 250b may be on both the 1-1 uncoated portion 211a and the 2-1 uncoated portion 211b. The second region 250b may be on at least a portion of the 1-1 uncoated portion 211a and the 2-1 uncoated portion 211b.

The first region 250a and the second region 250b of the partition wall 250 may include the same material. In one or more embodiments, the first region 250a and the second region 250b may be integral (e.g., monolithic).

The first region 250a may be configured to block lithium ion exchange between the first electrode assembly part 210 and the second electrode assembly part 220.

The second region 250b may increase the coupling strength of the partition wall 250. In one or more embodiments, the partition wall 250 may be prevented or at least mitigated from being separated from the secondary battery by the second region 250b. The shape of the first electrode assembly part 210 may be maintained by the second region 250b. In one or more embodiments, the second region 250b may fix the first electrode assembly part 210 at the lower part and/or upper part of the first electrode assembly part 210. Accordingly, the shape of the first electrode assembly part 210 may be prevented, reduced, or at least mitigated from changing due to stress.

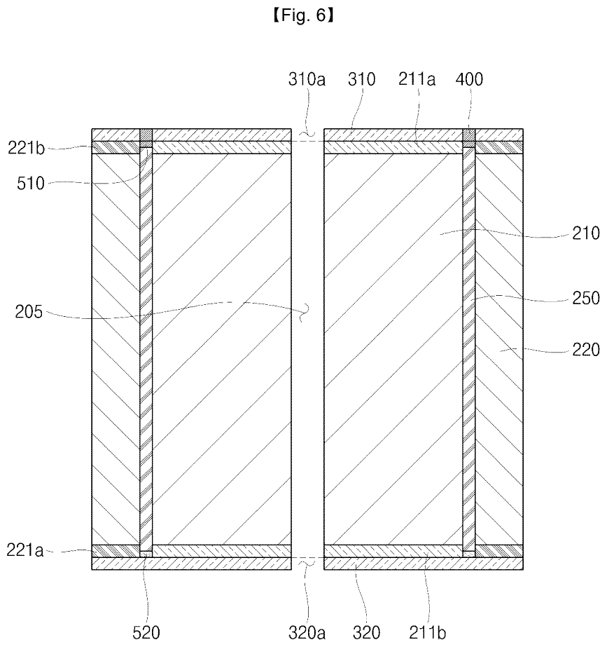

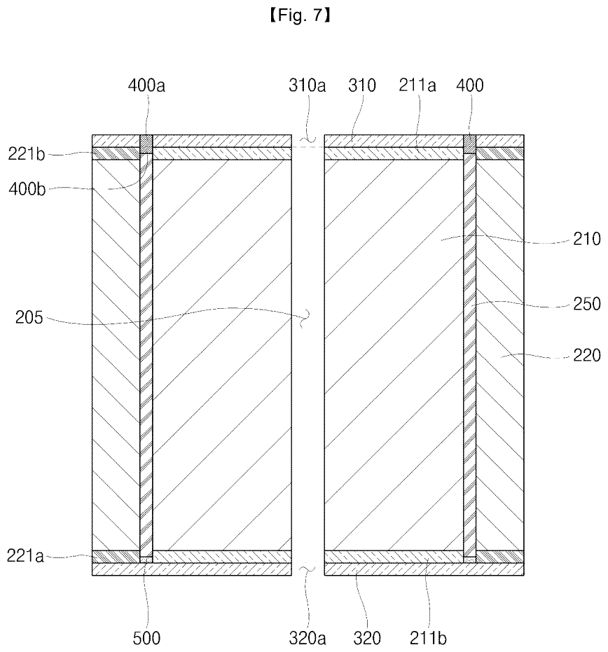

Referring to FIGS. 6 and 7, the secondary battery may include a blocking member.

Referring to FIG. 6, the blocking member may include a first blocking member 510 and a second blocking member 520.

The first blocking member 510 may be on the upper portion of the electrode assembly 200. The first blocking member 510 may be between the partition wall 250 and the insulating member 400. The first blocking member 510 may be in contact with the partition wall 250 and the insulating member 400. The first blocking member 510 may be between the 1-1 uncoated portion 211a and the 2-2 uncoated portion 221b. The first blocking member 510 may be in contact with at least one of the 1-1 uncoated portion 211a and the 2-2 uncoated portion 221b.

The first blocking member 510 may be formed in a closed loop (annular) shape corresponding the shape in which the partition wall 250 is provided.

The second blocking member 520 may be at the lower portion of the electrode assembly 200. The second blocking member 520 may be between the partition wall 250 and the second conductive plate 320. The second blocking member 520 may be in contact with the partition wall 250 and the second conductive plate 320. The second blocking member 520 may be between the 2-1 uncoated portion 211b and the 1-2 uncoated portion 221a. The second blocking member 520 may be in contact with at least one of the 2-1 uncoated portion 211b and the 1-2 uncoated portion 221a.

The second blocking member 520 may be formed in a closed loop (annular) shape corresponding to the shape in which the partition wall 250 is provided.

The blocking member 500 may include a resin material. The blocking member 500 may include a material identical to or similar to the partition wall 250.

The partition wall 250 is formed after the first electrode assembly part 210 is formed. When the partition wall 250 is formed, the partition wall 250 may not cover the entire outer surface of the first electrode assembly part 210 due to a manufacturing error. Accordingly, the first electrode assembly part 210 may include a region in which the outer surface is partially exposed. Accordingly, an electrolyte may be provided in this region, and the first electrode assembly part 210 and the second electrode assembly part 220 may exchange lithium ions through this region.

Therefore, the secondary battery includes the blocking member 500 to prevent or at least mitigate this exchange of lithium ions. The blocking member is provided in the exposed region. Accordingly, even if the exposed region is formed on the outer surface of the first electrode assembly part 210, movement of lithium ions between the first electrode assembly part 210 and the second electrode assembly part 220 may be blocked by the blocking member 500.

Referring to FIG. 7, the secondary battery may include one blocking member 500. For example, the blocking member 500 may be at the lower portion of the electrode assembly 200. The blocking member 500 may be between the partition wall 250 and the second conductive plate 320. The blocking member 500 may be in contact with the partition wall 250 and the second conductive plate 320. The blocking member 500 may be between the 2-1 uncoated portion 211b and the 1-2 uncoated portion 221a. The blocking member 500 may contact with at least one of the 2-1 uncoated portion 211b and the 1-2 uncoated portion 221a.

The blocking member 500 may be formed in a closed loop (annular) shape corresponding to the shape in which the partition wall 250 is provided.

The insulating member 400 may include a first region 400a and a second region 400b. The first region 400a and the second region 400b may include the same material. In one or more embodiments, the first region 400a and the second region 400b may be integral (e.g., monolithic).

The first region 400a may be in the hole of the first conductive plate 310. The second region 400b may be between the first region 400a and the partition wall 250. The second region 400b may be between the 1-1 uncoated portion 211a and the 201 uncoated portion 211b.

In one or more embodiments, the first blocking member 510 described above may be replaced by the second region 400a. Because the process of providing a separate first blocking member 510 is omitted, manufacturing process efficiency may be improved. Additionally, in general, when other members come into contact, a gap may be formed in the contact area. Therefore, the adhesive strength of the members may be reduced. Since the separate first blocking member 510 is omitted, the contact area between other members may be reduced. Accordingly, the movement of lithium ions by the electrolyte disposed in the gap may be prevented or reduced (mitigated).

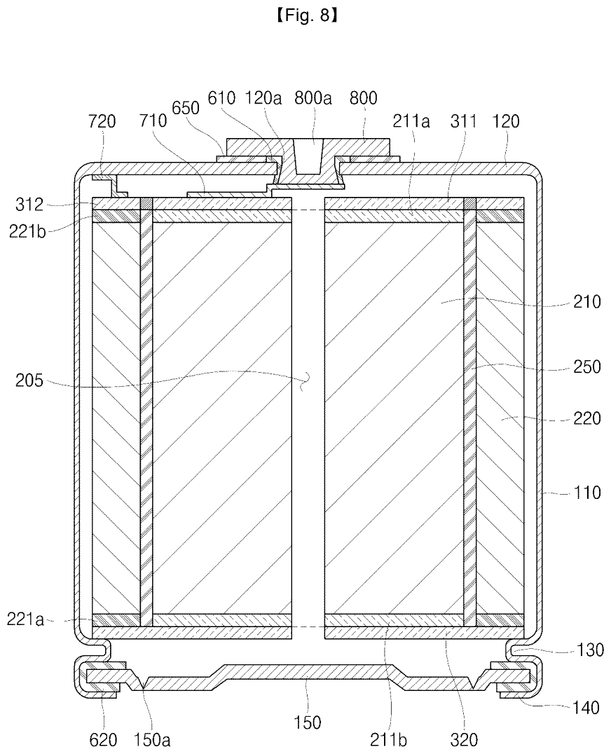

Hereinafter, with reference to FIGS. 1 and 8, a secondary battery including an electrode assembly according to the first embodiment will be described.

Referring to FIGS. 1 and 8, the electrode assembly 200 is accommodated inside the case 100.

The case 100 may include a side wall portion 110, a rivet plate 120, and a finishing plate 150.

The side wall portion 110 and the rivet plate 120 may be connected. For example, the side wall portion 110 and the rivet plate 120 may be integral (e.g., monolithic). In one or more embodiments, the side wall portion 110 and the rivet plate 120 may be coupled by welding.

The side wall portion 110 may form the shape of the case 100. For example, the side wall portion 110 may be formed in a circular shape. Accordingly, the case 100 may be formed in a cylindrical shape.

The side wall portion 110 may include a beading portion 130 and a crimping portion 140. The beading portion 130 may protrude toward the inside of the case (e.g., radially inward). That is, the outer surface of the side wall portion 110 where the beading portion 130 is formed may be concave. The crimping portion 140 may be bent toward the inside of the case 100 (e.g., radially inward) below the beading portion 130.

The beading portion 130 may prevent or at least mitigate the electrode assembly 200 from moving inside the case 100. The beading portion 130 may be configured to enable the seating of a second insulating gasket 620 and the finishing plate 150. The crimping portion 140 may firmly fix the finishing plate 150 by pressing the edge of the finishing plate 130 through the insulating gasket 500.

The rivet plate 120 may include a terminal hole 120a. A terminal 800 may be inserted through the terminal hole 120. A first insulating gasket 610 and an insulating portion 650 may be between the terminal 800 and the rivet plate 120. For example, the first insulating gasket 610 may be between the terminal 800 and the inner surface of the terminal hole 120a. The insulating portion 650 may be between the terminal 800 and the upper surface of the rivet plate 120.

The terminal 800 may be insulated from the rivet plate 120 by the first insulating gasket 610 and the insulating portion 650. Therefore, the terminal 800 is not electrically connected to the case 100.

The terminal 800 may be riveted to the terminal hole 120a.

A plurality of lead tabs may be between the rivet plate 120 and the electrode assembly 200. For example, a first lead tab 710 may be between the rivet plate 120 and the first electrode assembly part 210. In addition, a second lead tab 720 may be between the rivet plate 120 and the second electrode assembly part 220.

The first lead tab 710 may be in contact with the first conductive part 311 and the terminal 800. Accordingly, the first electrode assembly part 210 and the terminal 800 may be electrically connected by the first lead tab 710. Accordingly, the terminal 800 may be a positive terminal.

The second lead tab 720 may be in contact with the second conductive part 312 and the rivet plate 120. Accordingly, the second electrode assembly part 220 and the rivet plate 120 may be electrically connected by the second lead tab 720. Accordingly, the case 100 may be a negative terminal.

The terminal 800 may include a groove 800a. A laser beam may be easily transmitted to the welding surface of the terminal 800 and the first lead tab 710 by the groove 800a.

The finishing plate 150 may be connected to the side wall portion 110. For example, the finishing plate 150 and the side wall portion 110 may be coupled by welding.

The finishing plate 150 may include at least one notch 150a. The notch 150a may be a groove in the finishing plate. Therefore, the thickness of the region where the notch 150a is formed may be thinner than the thickness of other regions of the finishing plate 150. When the internal pressure of the secondary battery becomes higher than a reference pressure, the finishing plate 150 may be broken by the notch 150a, and the gas inside may be discharged to the outside.

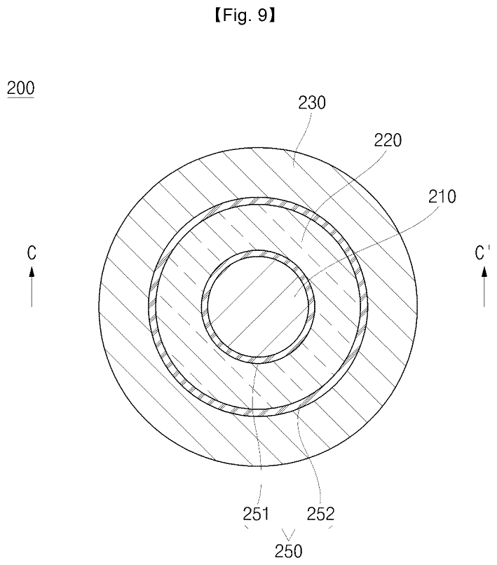

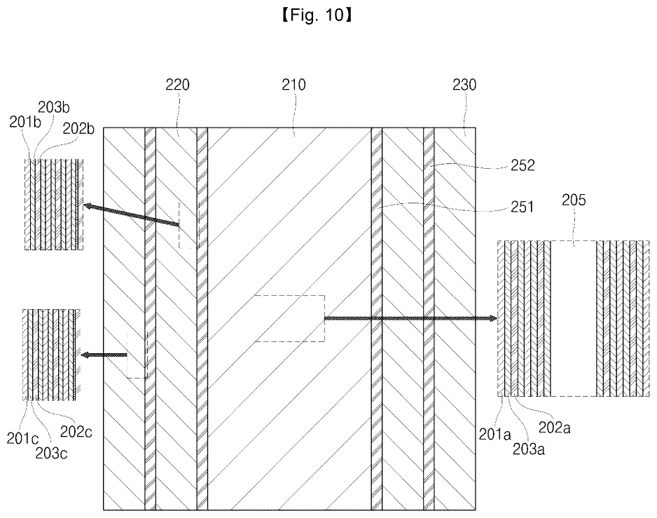

Hereinafter, a secondary battery according to a second embodiment will be described with reference to FIGS. 9 to 13. Commonalities with the first embodiment described above will be omitted. In addition, the same drawing reference numerals are given to the same configurations as those of the first embodiment.

Referring to FIGS. 9 to 13, the secondary battery according to the second embodiment may include the electrode assembly. The electrode assembly 200 may include a plurality of electrode assembly parts. For example, the electrode assembly 200 may include at least three or more electrode assembly parts. For example, the electrode assembly 200 may include a first electrode assembly part 210, a second electrode assembly part 220, and a third electrode assembly part 230. The first electrode assembly part 210, the second electrode assembly part 220, and the third electrode assembly part 230 may be concentric or substantially concentric.

The first electrode assembly part 210 may be wound in a jelly-roll shape. In one or more embodiments, the first electrode assembly part 210 may be wound in a state where the first separator 203a is between the 1-1 electrode 201a and the 2-1 electrode 202a.

In one or more embodiments, the first electrode assembly part 210 may include a hollow portion 205. The hollow portion 205 can be formed at the center (or substantially the center) of the winding of the first electrode assembly part 210.

The second electrode assembly part 220 may include the 1-2 electrode 201b, the 2-2 electrode 202b, and the second separator 203b.

The second electrode assembly part 220 may be wound in a jelly-roll shape. In one or more embodiments, the second electrode assembly part 220 may be wound in a state where the second separator 203b is between the 1-2 electrode 201b and the 2-2 electrode 202b. The second electrode assembly part 220 may be wound around the first electrode assembly part 210 with the first electrode assembly part 210 as an axis. Accordingly, the second electrode assembly part 220 does not include a separate hollow portion.

The third electrode assembly part 230 may include the 1-3 electrode 201c, the 2-3 electrode 202c, and the third separator 203c.

The third electrode assembly part 230 may be wound in a jelly-roll shape. In one or more embodiments, the third electrode assembly 230 may be wound in a state where the third separator 203c is between the 1-3 electrode 201c and the 2-3 electrode 202c. The third electrode assembly part 230 may be wound around the second electrode assembly part 220 with the second electrode assembly part 220 as an axis. Accordingly, the third electrode assembly part 230 does not include a separate hollow portion.

The 1-3 electrode 201c may include a 1-3 base material and a 1-3 active material layer. The 1-3 active material layer may be on the 1-3 base material. For example, the 1-3 active material layer may be on one surface and the other surface (i.e., an opposite surface) of the 1-3 base material.

The 1-3 base material may include a 1-3 uncoated portion 231a. The 1-1 active material layer is not provided on the 1-3 uncoated portion 231a. That is, the 1-3 uncoated portion 231a may be defined as an area where the 1-3 active material layer is not provided. The 1-3 uncoated portion 231a may be on the upper portion of the third electrode assembly part 230. In one or more embodiments, the 1-3 uncoated portion 231a may be on the lower portion of the first conductive plate 310.

The 1-1 electrode 201a, the 1-2 electrode 201b, and the 1-3 electrode 201c may include the same material. For example, the 1-1 base material, the 1-2 base material, and the 1-3 base material may include aluminum. In one or more embodiments, the 1-1 active material layer, the 1-2 active material layer, and the 1-3 active material layer may include a transition metal oxide.

The 2-3 electrode 202c may include a 2-3 base material and a 2-3 active material layer. The 2-3 active material layer may be on the 2-3 base material. For example, the 2-3 active material layer may be on one surface and the other surface (i.e., an opposite surface) of the 2-3 base material.

The 2-3 base material may include a 2-3 uncoated portion 231b. The 2-3 active material layer is not provided on the 2-3 uncoated portion 231b. That is, the 2-3 uncoated portion 231b may be defined as an area where the 2-3 active material layer is not provided. The 2-3 uncoated portion 231b may be at the lower portion of the third electrode assembly part 230. In one or more embodiments, the 2-3 uncoated portion 231b may be at the upper portion of the second conductive plate 320.

The 2-1 electrode 202a, the 2-2 electrode 202b, and the 2-3 202c electrode may include the same material. For example, the 2-1 base material, the 2-2 base material, and the 2-3 base material may include copper or nickel. In one or more embodiments, the 2-1 active material layer, the 2-2 active material layer, and the 2-3 active material layer may include graphite.

The third separator 203c may be between the 1-3 electrode 201c and the 2-3 electrode 202c.

The secondary battery may include a partition wall. The partition wall may include a plurality of partition walls. For example, the partition wall may include a first partition wall 251 and a second partition wall 252.

The first partition wall 251 may be between the first electrode assembly part 210 and the second electrode assembly part 220. The first electrode assembly part 210 and the second electrode assembly part 220 may be separated from each other by the first partition wall 251. In one or more embodiments, the first electrode assembly part 210 and the second electrode assembly part 220 do not contact each other due to the first partition wall 251.

The second partition wall 252 may be between the second electrode assembly part 220 and the third electrode assembly part 230. The second electrode assembly part 220 and the third electrode assembly part 230 may be separated by the second partition wall 252. In one or more embodiments, the second electrode assembly part 220 and the third electrode assembly part 230 do not contact each other due to the second partition wall 252.

Therefore, lithium ion exchange between the first electrode assembly part 210 and the second electrode assembly part 220 may be blocked (or at least mitigated) by the first partition wall 251. Additionally, lithium ion exchange between the second electrode assembly part 220 and the third electrode assembly part 230 may be blocked (or at least mitigated) by the second partition wall 252.

Therefore, the first electrode assembly part 210, the second electrode assembly part 220, and the third electrode assembly part 230 may be electrically separated while each having an individual voltage.

Therefore, the total voltage of the secondary battery may be determined by the voltages of the first electrode assembly part 210, the second electrode assembly part 220, and the third electrode assembly part 230. For example, the first electrode assembly part 210, the second electrode assembly part 220, and the third electrode assembly part 230 may be electrically connected. For example, the first electrode assembly part 210, the second electrode assembly part 220, and the third electrode assembly part 230 may be connected in series. Accordingly, the voltage of the secondary battery may be a sum of the voltages of the first electrode assembly part 210, the second electrode assembly part 220, and the third electrode assembly part 230.

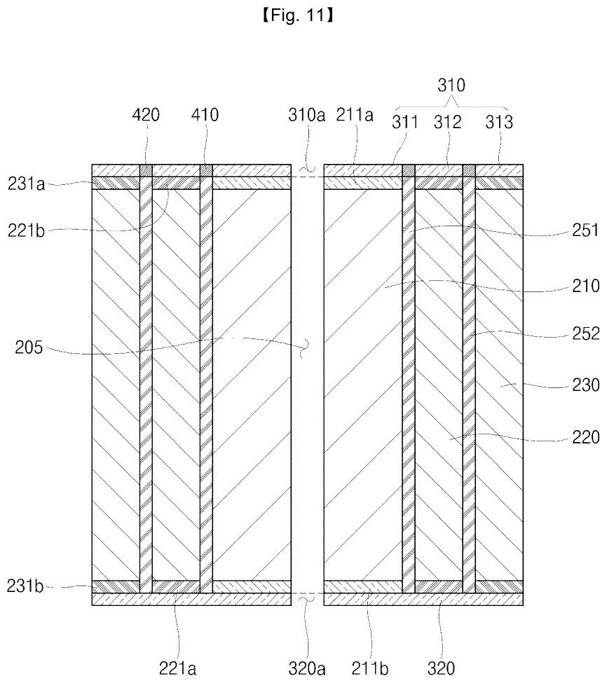

Referring to FIG. 11, the first conductive plate 310 may include a plurality of insulating members. For example, the insulating member may include a first insulating member 410 and a second insulating member 420. Accordingly, the first conductive plate 310 may include a first conductive part 311, a second conductive part 312, and a third conductive part 313. The first conductive part 311 and the second conductive part 312 may be separated from each other by the first insulating member 410. The first conductive part 311 and the second conductive part 312 may be insulated from each other by the first insulating member 410. The second conductive part 312 and the third conductive part 313 may be separated from each other by the second insulating member 420. The second conductive part 312 and the third conductive part 313 may be insulated from each other by the second insulating member 420.

The first conductive part 311 may be connected to the first electrode assembly part 210. The second conductive part 312 may be connected to the second electrode assembly part 220.

The third conductive part 313 may be connected to the third electrode assembly part 230. In one or more embodiments, the third conductive part 313 may be electrically connected to the 1-3 base material. In one or more embodiments, the third conductive part 313 may be electrically connected to the 1-3 uncoated portion (231a). For example, the third conductive part 313 and the 1-3 uncoated portion 231a may be coupled by welding. Accordingly, the first conductive part 313 may be electrically connected to the positive electrode of the third electrode assembly part 230.

The second conductive plate 320 may be connected to the electrode assembly 200. In one or more embodiments, the second conductive plate 320 may be electrically connected to the first electrode assembly part 210, the second electrode assembly part 220, and the third electrode assembly part 230.

The second conductive plate 320 may be connected to the third electrode assembly part 230. In one or more embodiments, the second conductive plate 320 may be electrically connected to the 2-3 base material. In one or more embodiments, the second conductive plate 320 may be electrically connected to the 2-3 uncoated portion 231b. For example, the second conductive plate 320 and the 2-3 uncoated portion 231b may be coupled by welding. Accordingly, the second conductive plate 320 may be electrically connected to the negative electrode of the third electrode assembly part 230.

The 2-1 uncoated portion 211b, the 1-2 uncoated portion 221a, and the 2-3 uncoated portion 231b may be connected by the second conductive plate 320. In one or more embodiments, the 2-1 uncoated portion 211b, the 1-2 uncoated portion 221a, and the 2-3 uncoated portion 231b may be connected in series by the second conductive plate 320.

Accordingly, the voltage of the electrode assembly 200 may be a sum of the voltages of the electrode assembly parts 210, 220, 230. In one or more embodiments, the positive electrode of the electrode assembly 200 may be the first electrode assembly part 210 and the third electrode assembly part 230. In one or more embodiments, the negative electrode of the electrode assembly 200 may be the second electrode assembly part 220.

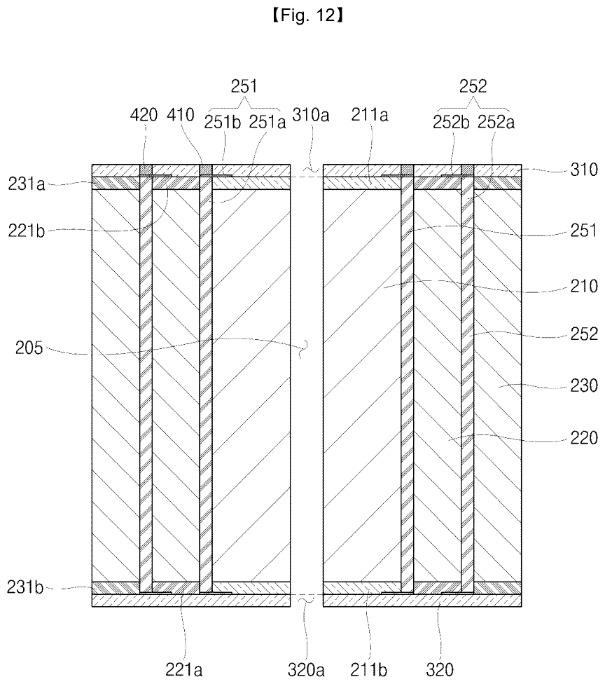

Referring to FIG. 12, the partition wall may be on at least one of the upper and lower surfaces of the first electrode assembly part 210.

For example, the first partition wall 251 may include a 1-1 region 251a and a 1-2 region 251b, and the second partition wall 252 may include a 2-1 region 252a and a 2-2 region 252b.

The 1-1 region 251a and the 2-1 region 252a may be between the respective electrode assembly parts 210, 220, 230. The 1-2 region 251b and the 2-2 region 252b may be partially on the upper and lower portions of the electrode assembly parts 210, 220, and/or 230.

Accordingly, the lithium ion exchange of the electrode assembly parts may be blocked by the 1-1 region 251a and the 2-1 region 252a. Additionally, the fixing force of the partition walls 251, 252 may be improved by the 1-2 region 251b and the 2-2 region 252b. Accordingly, the partition walls 251, 252 may be prevented or at least mitigated from being separated from the electrode assembly.

Although not shown in the drawing, the blocking member 510 and/or 520 described above may also be applied to the secondary battery according to the second embodiment.

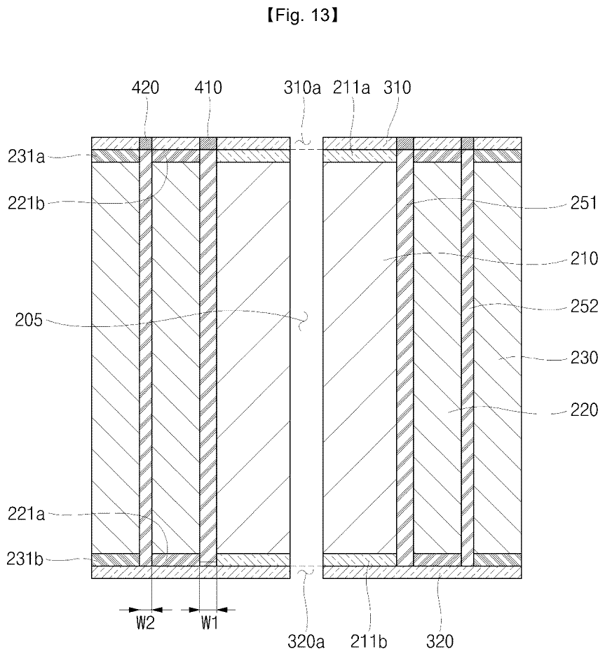

Referring to FIG. 13, the first partition wall 251 and the second partition wall 252 may have different sizes. For example, the widths of the first partition wall 251 and the second partition wall 252 may be different. For example, the first partition wall 251 may have a first width W1, and the second partition wall 252 may have a second width W2 different than the first width W1. The first width W1 may be larger than the second width W2.

The first partition wall 251 is adjacent to the winding center of the electrode assembly. By increasing the thickness of the first partition wall 251, the first electrode assembly part 21 may be fixed. Accordingly, when the first electrode assembly part 210 swells, the change in the shape of the first electrode assembly part 210 may be minimized or at least reduced. Accordingly, the first electrode assembly part 210 may be prevented or reduced from collapsing in the hollow portion of the electrode assembly.

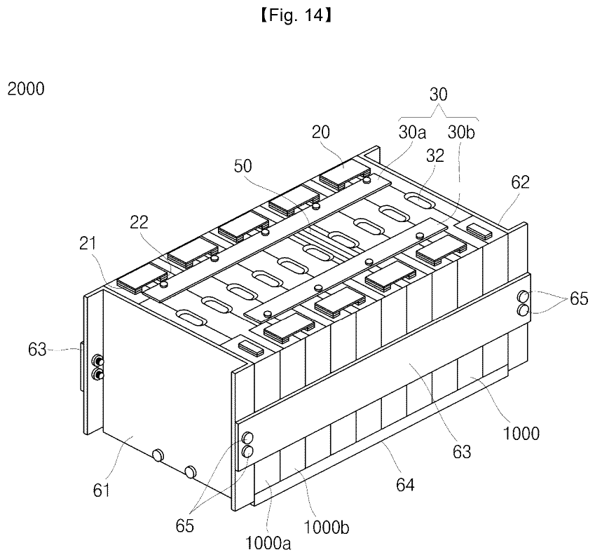

Hereinafter, a battery module including secondary batteries according to embodiments will be described with reference to FIG. 14.

Referring to FIG. 14, the battery module 2000 according to one or more example embodiments of the present disclosure includes electrode units 11 and 12, a plurality of secondary battery 1000 arranged in one direction, a connection tab 20 connecting a secondary battery 1000a to an adjacent secondary battery 1000b, and a protection circuit module 30 having one end connected to the connection tab 20. The protection circuit module 30 may include a battery management system (BMS). Further, the connection tab 20 may include a body portion in contact with the electrode units 11 and 12 between the adjacent secondary battery 1000a and 1000b and an extension portion extending from the body portion and connected to the protection circuit module 30. The connection tab 20 may be, for example, a bus bar.

Each secondary battery 1000 may include a battery case, an electrode assembly received (or accommodated) in the battery case, and an electrolyte. The electrode assembly and the electrolyte react electrochemically to store and release (e.g., generate) energy. Terminal parts 21 and 22 electrically connected to the connection tab 20 and a vent 32 as a discharge passage for gas generated inside the battery case may be provided on one side of (e.g., an upper side of) the secondary battery 1000. The terminal parts 21 and 22 of the secondary battery 1000 may be a positive electrode terminal 11 and a negative electrode terminal 12 having different polarities from each other, and the terminal parts 11 and 12 of the adjacent secondary battery 1000a and 1000b may be electrically connected to each other in series or parallel by the connection tab 20, to be described in more detail below. Although a serial connection has been described as an example, the connection structure is not limited thereto, and various connection structures may be employed as desired or necessary. In addition, the number and arrangement of secondary battery is not limited to the structure shown in FIG. 14 and may be changed as desired or necessary.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary battery batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 34 interposed therebetween but may be disposed parallel to the first protection circuit module 30a. As such, the two protection circuit modules are spaced from each other side-by-side along the direction in which the plurality of secondary batteries 1000 are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electric wire. In addition, the connection member 50 may be made of or include a material having elasticity or flexibility. By the connecting member 50, it may be possible to check and manage whether the voltage, temperature, and/or current of the plurality of secondary battery 1000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells, shocks may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 14.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

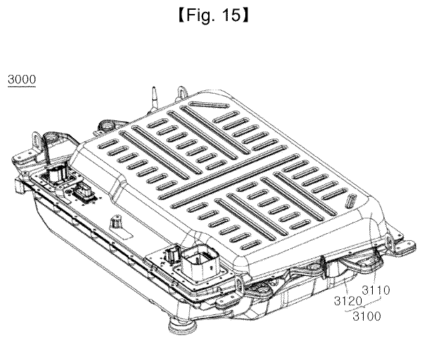

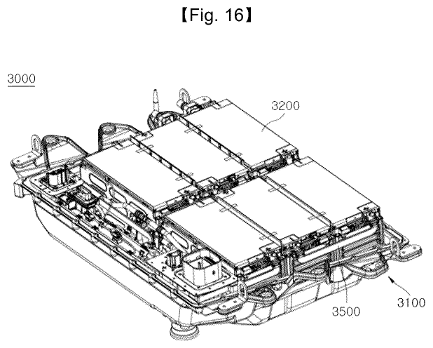

FIGS. 15 and 16 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

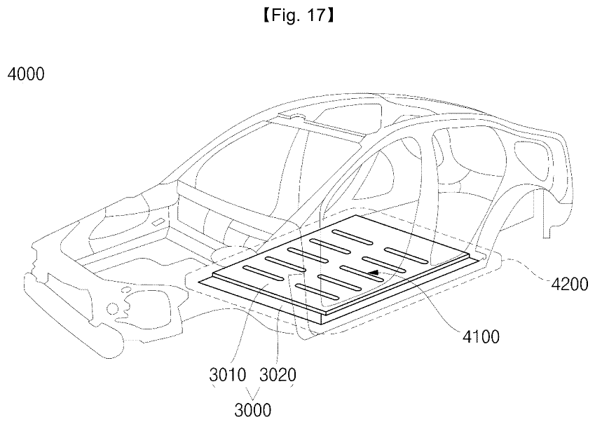

In FIG. 17, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

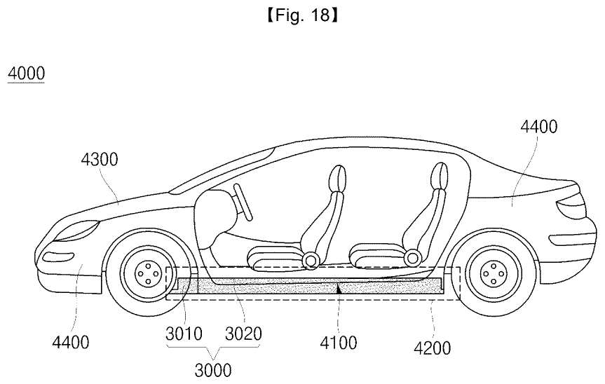

In FIG. 18, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. A secondary battery comprising:
a case; and
an electrode assembly, a partition wall, and a conductive plate accommodated in the case,
wherein the electrode assembly comprises a first electrode assembly part and a second electrode assembly part,
wherein the partition wall is between the first electrode assembly part and the second electrode assembly part,
wherein the conductive plate comprises a first conductive plate on the electrode assembly and a second conductive plate under the electrode assembly,
wherein the first conductive plate comprises a first conductive part and a second conductive part insulated from the first conductive part by an insulating member,
wherein the first conductive part is electrically connected to the first electrode assembly part,
wherein the second conductive part is electrically connected to the second electrode assembly part, and
wherein the second conductive plate is electrically connected to the first electrode assembly part and the second electrode assembly part.

2. The secondary battery as claimed in claim 1, wherein the first electrode assembly part comprises a 1-1 electrode, a 2-1 electrode, and a first separator,
wherein the second electrode assembly part comprises a 1-2 electrode, a 2-2 electrode, and a second separator,
wherein the 1-1 electrode comprises a 1-1 uncoated portion where an active material layer is not provided,
wherein the 2-1 electrode comprises a 2-1 uncoated portion where an active material layer is not provided,
wherein the 1-2 electrode includes a 1-2 uncoated portion where an active material layer is not provided,
wherein the 2-2 electrode includes a 2-2 uncoated portion where an active material layer is not provided,
wherein the 1-1 electrode and the 1-2 electrode are positive electrodes, and
wherein the 2-1 electrode and the 2-2 electrode are negative electrodes.

3. The secondary battery as claimed in claim 2, wherein the 1-1 uncoated portion is at an upper end of the first electrode assembly part,
wherein the 2-1 uncoated portion is at a lower end of the first electrode assembly part,
wherein the 1-2 uncoated portion is at a lower end of the second electrode assembly part,
wherein the 2-2 uncoated portion is at an upper end of the second electrode assembly part.

4. The secondary battery as claimed in claim 3, wherein the 1-1 uncoated portion and the 2-2 uncoated portion are electrically connected to the first conductive plate, and
wherein the 2-1 uncoated portion and the 1-2 uncoated portion are electrically connected to the second conductive plate.

5. The secondary battery as claimed in claim 2, wherein the partition wall comprises a different material than the first separator and the second separator.

6. The secondary battery as claimed in claim 1, wherein a thickness of the partition wall is in a range from approximately 20 μm to approximately 100 μm.

7. The secondary battery as claimed in claim 1, wherein the first electrode assembly part and the second electrode assembly part are connected in series.

8. The secondary battery as claimed in claim 1, wherein the first electrode assembly part has a first voltage,
wherein the second electrode assembly part has a second voltage, and
wherein the first voltage and the second voltage are same or different.

9. The secondary battery as claimed in claim 8, wherein a voltage of the electrode assembly is a sum of the first voltage and the second voltage.

10. The secondary battery as claimed in claim 1, wherein the partition wall comprises a resin, and
wherein the partition wall is configured to block movement of lithium ions.

11. The secondary battery as claimed in claim 4, wherein the partition wall comprises a first region and a second region,
wherein the first region is between the first electrode assembly part and the second electrode assembly part, and
wherein the second region is on a portion of at least one of the 1-1 uncoated portion and the 2-1 uncoated portion.

12. The secondary battery as claimed in claim 4, further comprising:
a first blocking member between the partition wall and the insulating member; and
a second blocking member between the partition wall and the second conductive plate.

13. The secondary battery as claimed in claim 4, further comprising a blocking member between the partition wall and the second conductive plate,
wherein the insulating member comprises a first region and a second region,
wherein the first region is in a hole of the first conductive plate, and
wherein the second region is between the first region and the partition wall.

14. The secondary battery as claimed in claim 4, wherein the electrode assembly further comprises a third electrode assembly part,
wherein the second electrode assembly part is between the first electrode assembly part and the third electrode assembly part,
wherein the third electrode assembly part comprises a 1-3 electrode, a 2-3 electrode, and a third separator,
wherein the 1-3 electrode comprises a 1-3 uncoated portion where an active material layer is not provided,
wherein the 2-3 electrode comprises a 2-3 uncoated portion where an active material layer is not provided,
wherein the 1-3 electrode is a positive electrode,
wherein the 2-3 electrode is a negative electrode,
wherein the 1-3 uncoated portion is at an upper end of the first electrode assembly part,
wherein the 2-3 uncoated portion is at a lower end of the first electrode assembly part,
wherein the 1-3 uncoated portion is electrically connected to the first conductive plate, and
wherein the 2-3 uncoated portion is electrically connected to the second conductive plate.

15. The secondary battery as claimed in claim 14, wherein the partition wall comprises a first partition wall between the first electrode assembly part and the second electrode assembly part, and a second partition wall between the second electrode assembly part and the third electrode assembly part.

16. The secondary battery as claimed in claim 15, wherein widths of the first partition wall and the second partition wall are different.

17. The secondary battery as claimed in claim 14, wherein the first electrode assembly part has a first voltage,
wherein the second electrode assembly part has a second voltage,
wherein the third electrode assembly part has a third voltage, and
wherein the first voltage, the second voltage, and the third voltage are same or different.

18. The secondary battery as claimed in claim 17, wherein a voltage of the electrode assembly is a sum of the first voltage, the second voltage, and the third voltage.
